(19) United States
(12) Patent Application Publication
(10) Pub. No.: US 2008/0295257 A1
(43) Pub. Date: Dec. 4, 2008

(54) METHOD FOR THE WET TREATMENT OF ITEMS OF LAUNDRY

(76) Inventors: Wilhelm Bringewatt, Porta Westfalica (DE); Engelbert Heinz, Vlotho (DE)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/123,532

(22) Filed: May 20, 2008

(30) Foreign Application Priority Data
May 29, 2007 (DE) 102007025058.6
Aug. 3, 2007 (DE) 102007036800.5

(51) Int. Cl. C11D 1/00

(52) U.S. Cl. 8/137

(57) ABSTRACT

According to the invention, provision is made for at least one treatment additive in the treatment liquid to be reused to be measured during operation of the pass-through washing machine and possibly the spin dryer which is arranged downstream of said pass-through washing machine. As a result, it is possible to establish whether the treatment liquid still contains a sufficient quantity of treatment additives before said treatment liquid is reused. On account of the established concentration of the respective treatment additive, the treatment additive can be deliberately added in a metered manner, so that the treatment liquid to be reused contains a sufficient concentration of the respective treatment additive.

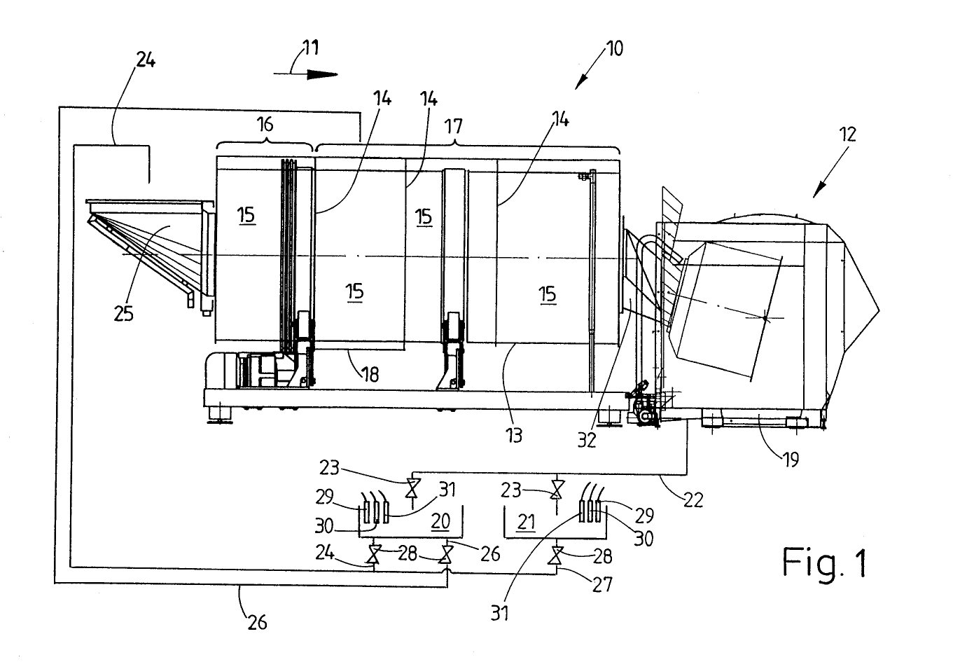

### STATEMENT OF RELATED APPLICATIONS

This application is based on and claims convention priority under 35 USC 119 on German Patent Application No. 10 2007 025 058.6 having a filing date of 29 May 2007 and on German Patent Application No. 10 2007 036 800.5 having a filing date of 3 Aug. 2007, both of which are incorporated herein by this reference in their entireties.

### BACKGROUND OF THE INVENTION

1. Technical Field

The invention relates to a method for the wet-treatment of items of laundry, with the laundry being washed with at least one treatment liquid which contains a treatment additive.

2. Prior Art

Both in commercial laundry machines and also in domestic washing machines, items of laundry are subjected to wet-treatment in a plurality of steps, to be precise by washing, rinsing and water removal, it also being possible for water removal to take place between washing and rinsing. Washing is performed by prewashing and subsequent final washing. Furthermore, the laundry can also be finished during wet-treatment.

The treatment liquid for the wet-treatment of laundry is replaced between at least some treatment steps. This is true primarily for the prewash and final wash liquid, the rinse liquid and possibly the finishing liquid.

It is customary to reuse the treatment liquid which is produced in at least some treatment steps. This not only reduces the fresh water requirement but above all prevents unconsumed treatment additives being lost. The treatment additives primarily include wash-active substances, disinfection-active substances, bleach-active substances and/or finishing substances. Only some of the abovementioned treatment additives are used, depending on the type of wet-treatment of the items of laundry and on the use, to be precise whether in commercial laundry facilities or private households. In order for the treatment liquid to be reused, it is often necessary for at least one fresh treatment additive to be additionally added to said treatment liquid, so that the concentration of the at least one treatment additive is sufficient for reuse of the treatment liquid. To date, it has been customary to add in a metered manner one or more treatment additives on the basis of empirical values. In order to ensure that the treatment liquid always contains a sufficiently high concentration of the respective treatment additive, a quantity of the respective treatment additive which is sufficient under all circumstances is added to the treatment liquid in a metered manner in practice. This excessive metering leads to unconsumed treatment additives together with consumed treatment liquid, for example the prewash liquid, being routed to the outlet, as a result of which they can contaminate purification plants and also the environment. Finally, excessive metering of treatment additives creates unnecessary extra costs.

### BRIEF SUMMARY OF THE INVENTION

The invention is therefore based on the object of providing a method for the economical wet-treatment of laundry in the domestic and commercial sectors.

A method for achieving this object is a method for the wet-treatment of items of laundry, with the laundry being washed with at least one treatment liquid which contains a treatment additive, wherein at least one treatment additive is measured during the wet-treatment process. Accordingly, provision is made for at least one treatment additive to be measured during operation or when the treatment process for the laundry is running. The respectively desired treatment additive can, to all intents and purposes, be measured “in situ”. The or each treatment additive which is relevant for the respective wet-treatment is expediently measured.

Measuring the at least one treatment additive in the treatment liquid during operation of the washing device does not only mean measurement during washing, rinsing or possibly finishing of the laundry, but also between washing, rinsing and/or finishing processes of successive batches of laundry. Provision is preferably made for the at least one treatment additive in the treatment liquid to be measured after the respective wet-treatment of a batch of laundry and before the wet-treatment of the subsequent batch of laundry.

Provision is preferably made for the proportion of the at least one treatment additive in the treatment liquid to be measured during return or in the course of recirculation of the treatment liquid. “Proportion” preferably means the concentration of the at least one treatment additive in the treatment liquid and/or the quantity of the treatment additive. By virtue of this, the quantity of the respective treatment additive or its concentration in the treatment liquid can be detected before the subsequent batch of laundry is treated with said treatment liquid. In this way, the treatment process can be continuously monitored. Measurement of the concentration of the most important treatment additives in the treatment liquid makes it possible to detect whether and in what quantity a respective treatment additive has to be added in a metered manner before reuse of the treatment liquid.

According to a preferred refinement of the method, provision is made for the proportion of the respective treatment additive in the treatment liquid to be reused to be measured before, or alternatively during, feeding of the treatment liquid, which contains the respective treatment additive, to the laundry to be treated. Therefore, the concentration of the respective treatment additive in the treatment liquid is detected before said treatment liquid is reused, and at least one metered addition operation can be performed before the treatment liquid which contains the treatment additive is returned to the laundry.

A further advantageous refinement of the invention makes provision for a plurality of successive measurements to be performed in order to determine the proportion of the respective treatment additive in the treatment liquid. All measurements are preferably carried out before the treatment liquid which contains the at least one treatment additive is returned to the laundry. On account of the plurality of measurements, it is possible to monitor subsequent metering of the relevant treatment additive. If it is found here that the desired concentration of the treatment additive in the treatment liquid is not yet sufficient, it is possible to perform renewed subsequent metering and, by further measurement, establish whether this is sufficient. If necessary, the measurements can be repeated until the desired concentration of the respective treatment additive is produced. As a result, the desired concentration of the respective treatment additive can be set very precisely.

The proportion of the respective treatment additive in the treatment liquid is preferably measured before the treatment liquid is reused. If said proportion of the respective treatment additive falls below a minimum proportion of treatment additive, subsequent metering is performed. The subsequently metered quantity can be determined on the basis of the measured concentration of the treatment additive, in particular if the quantity of treatment liquid is also known. If it is found that the concentration of the measured treatment additive in the treatment liquid is too low, the relevant treatment additive is subsequently metered. After this, provision is preferably made for a further measurement to check whether subsequent metering has led to the desired proportion or desired concentration of the treatment additive in the treatment liquid. This procedure ensures that the intended concentration of the treatment additive is contained in the treatment liquid when the treatment liquid is reused for wet-treatment, in particular for washing, finishing and/or rinsing the laundry.

Provision is preferably made for the concentration of the respective treatment additive to be measured while the treatment liquid which contains said treatment additive is in a storage tank. A treatment additive can be subsequently metered in such a deliberate and precise manner if this is required on account of a result of the concentration measurement, particularly if the quantity of treatment liquid in the reservoir is known.

It is also feasible to detect the concentration of the respective treatment additive during feeding of the treatment liquid to a new batch of laundry. In this case, new treatment additives which may be required are added in a metered manner during transportation of the treatment liquid to the next batch of laundry. In this case, the respectively added treatment additive is effectively mixed and the higher concentration, which is produced by the respective treatment additive being admixed, in the treatment liquid can be reliably established immediately after metered addition.

In a preferred refinement of the method, provision is made for the proportion of the at least one treatment additive in the treatment liquid, which is produced when water is removed from the laundry, to be detected. Said treatment liquid is preferably both the free liquor and also at least a large portion of the bound liquor in the treatment liquid which is separated from the laundry by means of a water-removal device.

According to an advantageous refinement of the invention, provision is made to measure the proportion of at least one treatment additive in the final wash liquid and/or in the rinse liquid, after said final wash liquid or rinse liquid, to be precise preferably also the bound liquor, has been separated from the laundry in water-removal device. After separation of the final wash liquid or the rinse liquid from the laundry, the concentration of the respective treatment additive in the final wash liquid and in the rinse liquid no longer changes until it is reused for the wet-treatment of the subsequent batch of laundry, so that, after separation of the rinse liquid or the final wash liquid from the laundry, it is possible to establish in a particularly reliable manner whether the rinse liquid or the final wash liquid can be reused for treatment of the next batch of laundry or at least one treatment additive has to be added in order to achieve the desired concentration again. The same process is followed if finishing liquid is to be reused.

According to an advantageous refinement of the method, the concentration of at least one treatment additive in the treatment liquid is established while said treatment liquid is temporarily stored. The treatment liquid containing the at least one treatment additive to be measured remains in at least one storage container for some time. This time can be used to establish the concentration of the relevant treatment additive in the treatment liquid to be reused, possibly also in a plurality of measurements. The treatment liquid is returned to the washing device, in particular washing machine, for the wet-treatment of a subsequent batch of laundry only when the intended concentration of at least one treatment additive in the treatment liquid is achieved by subsequent metering which may become necessary.

Provision is preferably made for the proportion of treatment additives, such as wash-active substances or additives, disinfection-active substances and additives and/or bleach-active substances or additives, in the treatment liquid to be detected during operation of the washing machine.

If a plurality of treatment additives are to be measured while the process is running, this can be done by means of individuals sensors for the respective treatment additive. For example, a tensiometer is used to measure wash-active treatment additives. A Cl sensor is particularly suitable for measuring bleach-active treatment additives. Finally, an H₂O₂ sensor is preferably provided for measuring disinfection-active treatment additives.

It is also possible to measure at least one treatment additive while the process is running by means of spectral analysis using, for example, at least one spectrometer. In this way, individual or preferably a plurality of treatment additives can be measured at the same time, but possibly all treatment additives can be measured at the same time, to be precise with regard to presence and quantity. These substances may be, for example, surfactants, active chlorine, H₂O₂ and/or peracetic acid. Spectral analysis permits rapid “in situ” measurements of the proportion, in particular the quantity, of the treatment additives.

### BRIEF DESCRIPTION OF THE DRAWINGS

A preferred exemplary embodiment of the invention is explained in greater detail below with reference to the drawing. The single FIGURE of the drawing shows a schematic side view of an apparatus for carrying out the method according to the invention.

### DETAILED DESCRIPTION OF PREFERRED EMBODIMENTS

The apparatus shown here represents an inline wash-in system for the wet-treatment of laundry in a commercial laundry facility. However, the invention is not restricted to this. The inline washing system of the exemplary embodiment shown has a pass-through washing machine 10 and a water-removal device which is downstream of said pass-through washing machine in the treatment direction 11. In the present case, the water-removal device is a laundry centrifuge 12. However, the water-removal device may also be in the form of a water-removal press.

The inline washing system is used to wash, rinse and remove water from any type of laundry, for example bed linen, table linen, items of clothing, items of workwear, floor mats or the like. If appropriate, the inline washing system can also be used to finish laundry. This finishing is usually performed after the laundry is rinsed. Water can be removed from the laundry both before and/or after it is rinsed.

The pass-through washing machine 10 has a drum 13 which can be driven in rotation about a preferably horizontal axis of rotation. In the drum 13, a plurality of chambers 15 which follow one another in the treatment direction 11 of the laundry (not shown) through the drum 13 are formed by transverse partition walls 14. The chambers 15 may be of the same size but may also be of different sizes. The pass-through washing machine 10 shown here has a four successive chambers 15, a first chamber 15 forming the prewash zone 16, while the three following chambers 15 form a final wash zone 17.

The pass-through washing machine 10 shown here does not have a rinse chamber. The laundry is rinsed in the at least one laundry centrifuge 12, which is arranged downstream of the pass-through washing machine 10, or in another water-removal device, for example a water-removal press.

The pass-through washing machine 10 permits bath exchange in the first chamber 15 of the final wash zone 17, for which reason the chamber 15 of the pass-through washing machine 10 which is second as seen in the treatment direction 11 has an associated watertight, stationary outer drum 18 which is used to discharge prewash liquid. The prewash liquid may also be discharged at the end of the prewash zone 16, that is to say in the first chamber 15 for forming the prewash zone 16. In this case, the said (first) chamber 15 has an associated outer drum 18. It is also feasible for one or each further chamber 15 of the final wash zone 17 to have an associated outer drum 18, in particular when the pass-through washing machine 10 operates in accordance with the countercurrent principle or finishing is to be performed in the pass-through washing machine 10. In areas where an outer drum 18 is provided, the drum 13 has an at least partially liquid-permeable, for example perforated, drum casing.

The laundry centrifuge 12 has a collection tank 19 which can be formed, for example, from the base of the laundry centrifuge 12. Two separate storage tanks 20, 21 are also provided. Each storage tank 20, 21 is connected to the collection tank 19 of the laundry centrifuge 12 via a supply line 22. The supply line 22 can be shut off by a dedicated valve 23 upstream of each storage tank 20, 21.

An outflow line 24 leads from the storage tank 20 to the first chamber 15 of the pass-through washing machine 10, that is to say to the single chamber 15 of the prewash zone 16. In the exemplary embodiment shown, the outflow line 24 leads to a feed funnel 25 of the pass-through washing machine 10 upstream of the drum 13. The items of laundry to be washed pass from the feed funnel 25 to the first chamber 15 which forms the prewash zone 16. A second outflow line 26 leads from the storage tank 20 to the first chamber 15 of the final wash zone 17, that is to say to the second chamber 15 of the pass-through washing machine 10 shown here.

Only one outflow line 27 leads from the second storage tank 21 to the feed funnel 25 upstream of the first chamber 15 of the prewash zone 16. The outflow lines 24, 26 and 27 each have an associated valve 28, as a result of which deliberate emptying of the storage tanks 20, 21 can be controlled.

In the apparatus shown here, each storage tank 20, 21 has at least one associated sensor for measuring the treatment additive. According to the exemplary embodiment of the FIGURE, each storage tank has three sensors 29, 30, 31 for measuring the concentration of different treatment additives in the treatment liquid. The sensor 29 may be, for example, a tensiometer for detecting the concentration of wash-active substances in the treatment liquid. The sensor 30 may be in the form of an active chlorine sensor. This sensor can be used to determine disinfection-active substances of the treatment liquid.

The sensor 31 may be in the form of a so-called H₂O₂ sensor. This sensor can be used to establish the content of bleach-active substances in the treatment liquid.

The measurement can be performed using a single sensor if said sensor is a spectrometer. In this case, each storage tank 20, 21 can have its own associated spectrometer. However, for cost reasons, it is advisable to provide a single spectrometer, which is selectively supplied with treatment liquid from the storage tank 20 or 21, in order to measure the treatment liquid in the respective storage tank 20 or 21. The spectrometer is preferably used to measure the quantity of treatment additives in the treatment liquid. A plurality of treatment additives, in particular surfactants, active chlorine, H₂O₂ and peracetic acid, whose quantity can be determined using a spectrometer can be measured at the same time.

A preferred exemplary embodiment of the method according to the invention is explained in greater detail below with reference to the drawing:

The laundry is first prewashed in the prewash zone 16 of the pass-through washing machine 10. The laundry is then subjected to final washing in the final wash zone 17 of the pass-through washing machine 10. Before final washing, at least a portion of the treatment liquid, specifically prewash liquid, is discharged from the first chamber 15 of the final wash zone 17 and routed to the outlet.

After final washing, the laundry, together with all the final wash liquor, leaves the pass-through washing machine 10 via a discharge chute 32. The laundry is then loaded into the at least one laundry centrifuge 12. The laundry centrifuge 12 initially removes water from the laundry arriving from the pass-through washing machine 10. In the process, the laundry is separated from all the prewash liquid, to be precise both from the free liquor and from the bound liquor, to the extent that this liquor can be removed from the laundry by the laundry centrifuge 12 or a water-removal press. A maximum possible proportion of the bound liquor of the final wash liquid is separated from the laundry by the laundry centrifuge 12, so that the laundry contains only a small residual proportion of the bound liquor of the final wash liquid. The final wash liquid which is removed from the laundry in the laundry centrifuge 12 is passed initially to the collection tank 19 of the laundry centrifuge 12, and from there to the storage tank 20 via the supply line 22. The storage tank 20 accordingly serves to accommodate all the final wash liquid which has been removed from the laundry by the laundry centrifuge 12.

After water is removed from the laundry, said laundry is rinsed in the laundry centrifuge 12. To this end, fresh water is added to the laundry in the laundry centrifuge 12 and the laundry is then rinsed by, preferably multiple, successive water-removal processes. After rinsing, the laundry centrifuge 12 also removes the rinse liquid from the laundry, to be precise once again the free rinse liquid and a large portion of the bound rinse liquid, specifically to the extent that is possible using the laundry centrifuge 12. The residual rinse liquid is drawn from the laundry during the subsequent drying process. All the rinse liquid is initially captured in the collection tank 19 beneath the laundry centrifuge 12 and then conducted to the storage tank 21 for only rinse liquid via the supply line 22.

Both the rinse liquid and the final wash liquid are reused for the purpose of washing the next batch of laundry in the pass-through washing machine 10. Accordingly, the rinse liquid and the final wash liquid are recirculated between successive wash processes in the pass-through washing machine 10. This is done during operation of the pass-through washing machine 10 and the laundry centrifuge 12 because a plurality of batches of laundry are simultaneously washed in the pass-through washing machine 10 by a first batch of laundry being transferred to the final wash zone 17 after being prewashed, and a new subsequent batch being loaded into the prewash zone 16. When the first batch of laundry is in the laundry centrifuge 12, the second batch of laundry is transferred to the final wash zone 17, and a third batch of laundry is washed into the prewash zone 16. Therefore, three batches of laundry are simultaneously subjected to wet-treatment during operation of the pass-through washing machine 10 and the laundry centrifuge 12. Therefore, the pass-though washing machine 10 and the laundry centrifuge 12 operate in a continuous and substantially uninterrupted manner since the batches of laundry are continuously subjected to wet-treatment both in the pass-through washing machine 10 and in the laundry centrifuge 12 one after the other. The treatment liquid to be reused, in particular the final wash liquid and the rinse liquid, is continuously recirculated during operation of the pass-through washing machine 10 and the laundry centrifuge 12.

A portion of the final wash liquid from the storage tank 20 and all the rinse liquid from the storage tank 21 are fed to the prewash zone 16 via the feed funnel 25 and are used to prewash the next batch of laundry. The remaining portion of final wash liquid from the storage tank 20 is conducted to the start of the final wash zone 17 via the supply line 26 in order to at least partially refill the discharged portion of the prewash liquid. Therefore, this portion of the final wash liquid from the storage tank 20 is reused for final washing purposes.

According to the invention, provision is made to measure at least one treatment additive during operation of the pass-through washing machine 10 and/or the laundry centrifuge 12. The quantity and/or concentration of the respective treatment additive in the treatment liquid are/is preferably continuously measured. In the exemplary embodiment shown, the concentration of a plurality of treatment additives in the final wash liquid and the rinse liquid is measured “in situ”. In the apparatus shown, this measurement is performed before renewed feeding of the final wash liquid and the rinse liquid to the pass-through washing machine 10 in order to treat, preferably to wash, a subsequent batch of laundry with the final wash liquid and the rinse liquid.

In the present exemplary method, at least one treatment additive in the final wash liquid and rinse liquid in the storage tank 20 and 21 is measured during operation of the pass-through washing machine 10 and the laundry centrifuge 12. It is feasible to optionally simultaneously measure various treatment additives, which are material to the result of the wet-treatment, during operation of the pass-through washing machine 10 and the laundry centrifuge 12. By way of example, the treatment additives may be wash-active substances, disinfection substances and/or bleach-active substances. The wash-active substances include, for example, surfactants or other detergents or detergent aids. The disinfection-active substance may be chlorine. Bleach-active substances may be active oxygen, peracetic acid or the like. However, it is also feasible to measure other substances or only a portion of said substances.

In the exemplary embodiment shown, it is assumed that wash-active substances, disinfection-active substances and bleach-active substances are measured “in situ” when the treatment process is running. The three sensors 29, 30 and 31 which are associated with each storage tank 20 and 21 are used for this purpose. Each sensor 29, 30 and 31 measures a different substance. The sensors are H₂O₂ sensors, active chlorine sensors and/or tensiometers. The latter are used primarily for measuring wash-active substances. The H₂O₂ sensor is used to measure bleach-active substances, whereas the Cl sensor measures disinfection-active substances.

In the alternative method, provision is made to use a sensor with which various substances can be simultaneously measured “in situ”, to be precise preferably also with regard to quantity. In this alternative method, provision is preferably made to use a spectrometer, in particular a mass spectrometer. A single spectrometer which measures one or more substances in the treatment liquid in the storage tank 20 and 21 is preferably used. To this end, a changeover is expediently made by the substances in the treatment liquid in the storage tank 20 or alternatively in the storage tank 21 being separately measured one after the other, so that the quantity of the substances in the storage tank 20 and 21 can be obtained separately. The spectrometer is used to detect wash-active substances, disinfection-active substances and bleach-active substances when the treatment process is running, preferably simultaneously, in one measurement process. The quantity of surfactants, active chlorine, H₂O₂ and peracetic acid in the treatment liquid is preferably measured, to be precise simultaneously, in one measurement process. The spectrometer is first “calibrated” by measurements being carried out with known substances, to be precise preferably a plurality of measurements with various quantities. The preferably graphic displays of the measurement results of the spectrometer are then compared with the graphic measurement results during the “in situ” measurement. By means of the measurements made when the treatment process is running, specifically the graphic measurement results, a comparison is made with the graphic measurement results obtained during “calibration”. As a result, the presence and the quantity of the substance to be respectively measured, to be precise preferably all the substances to be detected, can then be detected.

However, it is also feasible to carry out the method according to the invention using other suitable sensors, or to measure further treatment additives, for example substances for finishing the laundry.

If during measurement in the storage tanks 20 and 21, it is established that the final wash liquid and/or the rinse liquid contains an excessively low concentration, deliberate subsequent metering is performed during operation of the pass-through washing machine 10 and the laundry centrifuge 12. If the sensors 29, 30 and 31 do not directly measure the concentration of the substances in the final wash liquid and/or in the rinse liquid, the concentration of the respective additive in the final wash liquid and in the rinse liquid is calculated, to be precise from the measured quantity of treatment additive, a ratio being formed between this measured quantity and the known quantity (volume) of the rinse liquid and the final wash liquid in the respective storage tank 20, 21.

If, during the measurement, it is found that the concentration of a substance in the final wash liquid or the rinse liquid is too low, subsequent metering is performed. To this end, a corresponding quantity of the substance to be subsequently metered is added to the relevant storage tank 20 or 21 and, if appropriate, mixed with the final wash liquid or the rinse liquid by a stirring apparatus in the storage tank 20, 21. At least one subsequent measurement is used to detect whether the minimum concentration of the respective substance (treatment substance) is reached after the metered addition or whether the concentration still falls below the desired concentration or is within a desired concentration range. If it is found that this is not the case, corresponding subsequent metering is performed once again and detection is again performed to determine whether the desired concentration or desired concentration range of the checked treatment additive is then present in the final wash liquid and in the rinse liquid.

It is also feasible to perform the measurement of the concentration of the treatment additive to be measured as early as in the supply line 22 or in at least one of, preferably all, the outflow lines 24, 26 and 27. In this case, the sensors 29, 30 and 31 are arranged in said lines, to be precise in the number which is necessary to be able to measure the desired treatment additives during operation of the pass-through washing machine 10 and the laundry centrifuge 12. Then, the concentration of the treatment additives in the final wash liquid and/or in the rinse liquid is not only measured during recirculation of these liquids, but subsequent metering is also performed. If, after subsequent metering, it is still necessary to measure the resulting concentration, further sensors have to be arranged in the supply line 22 and at least one outflow line 24, 26 and 27 downstream of the point at which treatment additives are added in a metered manner. However, this can be dispensed with if, in accordance with an alternative of the method according to the invention, subsequent metering is performed in a deliberate manner such that subsequent measurement to check the resulting concentration of the respective treatment additive in the final wash liquid and in the rinse liquid is superfluous.

The method according to the invention is also suitable for pass-through washing machines other than the described pass-through washing machine, in particular pass-through washing machines which have a rinse zone and/or a finishing zone. In addition, the method according to the invention is also suitable for domestic washing machines, spin dryers and other devices for the wet-treatment of any type of laundry.

### LIST OF REFERENCE SYMBOLS

10 Pass-through washing machine
11 Treatment direction
12 Laundry centrifuge
13 Drum
14 Partition wall
15 Chamber
16 Prewash zone
17 Final wash zone
18 Outer drum
19 Collection tank
20 Storage tank
21 Storage tank
22 Supply line
23 Valve
24 Outflow line
25 Feed funnel
26 Outflow line
27 Outflow line
28 Valve
29 Sensor
30 Sensor
31 Sensor
32 Discharge chute

What is claimed is:

1. A method for the wet-treatment of items of laundry, with the laundry being washed with at least one treatment liquid which contains a treatment additive, wherein at least one treatment additive is measured during the wet-treatment process.

2. The method as claimed in claim 1, wherein the proportion of the respective treatment additive in the treatment liquid is measured during operation of a washing machine which is used for wet-treatment.

3. The method as claimed in claim 1, wherein the proportion of the respective treatment additive in the reusable treatment liquid is measured before reuse of the treatment liquid for the wet-treatment of the next batch of laundry.

4. The method as claimed in claim 1, wherein the proportion of the at least one treatment additive in the reused treatment liquid is measured at the latest during recirculation of the treatment liquid which contains the at least one treatment additive.

5. The method as claimed in claim 1, wherein the at least one treatment additive in the treatment liquid is measured between the wet-treatment of successive batches of laundry.

6. The method as claimed in claim 1, wherein a single measurement is carried out to determine the proportion of the respective treatment additive in the treatment liquid.

7. The method as claimed in claim 1, wherein the proportion of the relevant treatment additive in the treatment liquid is first measured, and treatment additive is subsequently metered when the proportion of treatment additive falls below a minimum proportion of the measured treatment additive.

8. The method as claimed in claim 7, wherein at least one subsequent measurement checks whether subsequent metering has led to a proportion of the relevant treatment additive in the treatment liquid which corresponds to a desired proportion.

9. The method as claimed in claim 1, wherein the at least one treatment additive in the treatment liquid is measured while the treatment liquid containing the treatment additive to be measured is temporarily stored in at least one storage tank (20, 21).

10. The method as claimed in claim 1, wherein the proportion of the at least one treatment additive in the treatment liquid, which is produced when water is removed from the laundry, is detected.

11. The method as claimed in claim 10, wherein the proportion of the at least one treatment additive in the treatment liquid, which is separated by means of at least one water-removal device, is measured.

12. The method as claimed in claim 1, wherein the proportion of the at least one treatment additive in the final wash liquid is measured.

13. The method as claimed in claim 1, wherein the proportion of the at least one treatment additive in the rinse liquid is measured.

14. The method as claimed in claim 1, wherein the proportion of the at least one treatment additive in all the final wash liquor and rinse liquid is detected.

15. The method as claimed in claim 1, wherein the proportion of treatment additives, such as wash-active additives, disinfection-active additives and bleach-active additives, in the treatment liquid is measured during the wet-treatment.

16. The method as claimed in claim 15, wherein the proportion of at least one treatment additive is detected by spectral analysis.

17. The method as claimed in claim 15, wherein at least one tensiometer is used to measure wash-active treatment additives.

18. The method as claimed in claim 15, wherein a Cl sensor is used to measure bleach-active treatment additives.

19. The method as claimed in claim 15, wherein an H₂O₂ sensor is used to measure disinfection-active treatment additives.
